(19) United States
(12) Patent Application Publication
(10) Pub. No.: US 2024/0417249 A1
(43) Pub. Date: Dec. 19, 2024

(54) APPARATUS AND METHOD

(71) Applicant: THE UNIVERSITY OF LIVERPOOL, Liverpool (GB)

(72) Inventors: Xin TU, Liverpool (GB); Yichen MA, Liverpool (GB)

(21) Appl. No.: 18/701,221

(22) PCT Filed: Oct. 14, 2022
(86) PCT No.: PCT/GB2022/052620

§ 371 Date: Apr. 13, 2024

(30) Foreign Application Priority Data
Oct. 15, 2021 (GB) 2114775.6

(51) Int. Cl. C01B 3/24; C01B 32/16; C01B 32/184; C01B 32/205

(52) U.S. Cl. CPC C01B 3/24; C01B 32/16; C01B 32/184; C01B 32/205; C01B 2203/0861; C01B 2203/1241; C01B 2203/1614

(57) ABSTRACT

An apparatus for forming CO2-free hydrogen and carbon nanomaterials from methane is described. The apparatus comprises: a gliding arc discharge, GAD, device arranged to generate a plasma; and a passageway including an inlet for the methane and an outlet for the hydrogen and carbon and/or carbon nanomaterials, wherein the passageway extends, at least in part, through the GAD device wherein, in use, the methane is reacted in the generated plasma at temperatures of at most 400° C. and atmospheric pressure, thereby forming the hydrogen from at least some of the methane. A method is also described.

### FIELD

The present invention relates to an apparatus and method for use in methane cracking. Particularly, the present invention relates to an apparatus and method for use in methane cracking using a gliding arc discharge (GAD) device. The present invention particularly relates to an apparatus and method for use in methane cracking without any carbon dioxide emission.

### BACKGROUND

Hydrogen is increasingly seen as a zero-carbon, zero-pollution energy vector and is commonly used in fuel-cells to power vehicles. There are rapidly developing plans for its use in both industrial processes and domestic heating.

Hydrogen use today is dominated by industry including oil refining, ammonia production, methanol production and steel production. The refining and chemicals industries account for more than 80% of hydrogen demand.

Currently, however, hydrogen is primarily produced using steam methane reforming (SMR), resulting in 500 million tons of CO₂ emissions a year and accounting for over 1% of global greenhouse gases. Whilst CO₂ can be sequestrated by combining CO₂ capture and storage (CCS) with the SMR process to produce hydrogen, but inevitably increases the cost of hydrogen production.

Typically, CCS can only capture around 80% of CO₂ emitted from the SMR in the production of hydrogen. One promising alternative to SMR is the use of water electrolysis using renewable energy to produce zero-carbon hydrogen (otherwise known as green hydrogen). However, this is currently a more costly alternative compared to the SMR with the CCS route.

There is thus a need to develop alternative methods to produce affordable hydrogen, limiting CO₂ production.

### SUMMARY OF THE INVENTION

It is one aim of the present invention, amongst others, to provide an apparatus and method for converting methane into hydrogen, preferably CO₂-free hydrogen, which at least partially obviates or mitigates at least some of the disadvantages of the prior art, whether identified herein or elsewhere. For instance, it is an aim of embodiments of the invention to provide an apparatus to provide hydrogen from methane, with high hydrogen selectivity, high energy efficiency for methane conversion and low energy cost of hydrogen production.

The inventors have also found that the apparatus and method of the present invention can be used to generate carbon and/or carbon nanomaterials, as well as hydrogen.

Carbon is in demand for a wide range of applications such as rubber, tires, inks, plastics and batteries. The current market for carbon is about 15M tonnes per year with predictions of a growth rate of over 5%. However, a majority of the carbon market is currently fulfilled by partial combustion of fossil fuels with associated greenhouse gas emissions. Therefore there is also a need to generate “clean” carbon.

The present invention is able to convert methane into hydrogen and carbon-based materials with no carbon dioxide emission, offering significant advantages over methods of the prior art. Moreover, the present invention is able to operate at lower temperatures compared to the higher temperatures used in the prior art. The present invention can also be used without any catalysts or substrates for the production of carbon nanomaterials.

### DETAILED DESCRIPTION OF THE INVENTION

According to the present invention there is provided an apparatus, as set forth in the appended claims. Also provided is a method. Other features of the invention will be apparent from the dependent claims, and the description that follows.

### Apparatus

The apparatus is suitable for forming hydrogen and carbon nanomaterials from methane sourced from, for example, natural gas, shale gas, flared methane and biomethane. The apparatus is suitably for forming gaseous hydrogen and solid carbon nanomaterials. For the avoidance of doubt, the methane is provided in gaseous form. The methane may be used in combination with other gases or impurities such nitrogen and oxygen. Other impurities such as carbon dioxide and hydrocarbons (including other short chain hydrocarbons) may be present.

Preferably, nitrogen is present in an amount of less than 3%, based on mol %. For example, nitrogen may be present in an amount of from 1 to 2%, based on mol %. Suitably, no nitrogen is present.

Preferably, carbon dioxide is present in an amount of less than 1%, based on mol %.

Preferably, no carbon dioxide is present.

Preferably, no helium is present.

Preferably, no argon is present.

Preferably, hydrocarbons (other than methane) are present in an amount of less than 1000 ppm.

Suitably the purity of methane is at least 60%, for example at least 70% or at least 80%, for example at least 90% or at least 95%, such as at least 98%, based on mol %. Methods of determining methane purity include gas chromatography (GC) and spectroscopy, which are well known to the skilled person.

Suitably the methane is “pure” methane. Suitably the methane is substantially free of contaminants or impurities. Suitably, the methane contains less than 5% total impurities, for example less than 1% total impurities, based on mol %.

The formed carbon nanomaterials may alternatively be referred to herein as carbon nanoparticles. The formed carbon nanomaterials may comprise graphite. The formed carbon nanomaterials may comprise carbon nanotubes, suitably single-walled carbon nanotubes or multi-walled carbon nanotubes. The formed carbon nanomaterials may comprise graphene, suitably multilayer graphene. Suitably the carbon nanomaterials have a diameter of 10 to 70 nm, for example 20 to 50 nm, as determined by transmission electron microscopy (TEM).

Suitably the formed carbon nanomaterials do not comprise spherical carbon nanoparticles.

Methods of characterising carbon nanomaterials will be known to those skilled in the art and include TEM and Raman spectroscopy.

Other products may be formed in use, for example carbon, which is suitably in the form of carbon black.

Further products that may be formed in use include hydrocarbons, such as short chain alkynes, alkenes, and alkanes, for example unconverted CH₄, C₂H₂, C₂H₄, C₂H₆, C₃H₈, and C₄H₁₀ in gaseous form. When such further products form, hydrogen will be separated and the unconverted CH₄ and any further hydrocarbons will be recycled. In preferred embodiments, hydrogen comprises a majority of the products, suitably greater than 60 vol. %, such as greater than 70 vol. % or greater than 80 vol. % of the products.

Suitably the hydrogen is “pure” hydrogen containing no contaminants. Suitably the purity of hydrogen is at least 60%, for example at least 70% or at least 80%, for example at least 90% or at least 95%, such as at least 98%, based on mol %. Methods of determining hydrogen purity include gas chromatography (GC) and spectroscopy, which are well known to the skilled person. Suitably the hydrogen is substantially free of contaminants.

In particularly preferred embodiments, in use, no carbon dioxide is formed. Thus, the hydrogen formed in use may suitably be referred to herein as “CO₂-free hydrogen”. Suitably carbon dioxide is present in an amount less than 1%, suitably less than 0.5%, such as less than 0.1% or less than 0.05%, based on mol %. In one example, carbon dioxide is present in an amount of less than 0.01% or less than 0.001%, based on mol %. Suitably, no syngas is formed. This provides significant advantages over methods of the prior art in which carbon dioxide is formed in use of the apparatus.

The apparatus comprises the GAD device.

Gliding arc plasma is a type of non-thermal and non-equilibrium plasma. Compared to other types of non-thermal plasma, gliding arc has a very high electron density of ˜10²³ m⁻³ (close to thermal plasma) which results in a desirable energy efficiency for chemical synthesis such as methane cracking.

Typically, the gliding arc plasma device comprises two divergent electrodes, where the arc starts at the shortest distance between the electrodes, then driven by the gas flow and the length of the arc column increases together with the voltage. The potential to trigger and sustain the gliding arc discharge can be direct current (DC), alternating current (AC) or pulsed power supply source. It should be understood that the electrodes are thus electrical conductors. The electrodes may be any suitable metal.

In one example, the gliding arc discharge device comprises a pair (i.e. two) of thin diverging stainless steel electrodes. In one example, the electrodes may be described as being knife-shaped (i.e. lancet shaped), for example having one or more sharpened edges. In one example, the electrodes are wire electrodes. Suitable electrodes will be known by the skilled person. The electrodes suitably have a thickness of up to 5 mm, such as 4 mm or up to 3 mm. In one example, the electrodes have a thickness of 3 mm. The electrodes are suitably fixed symmetrically on a support, such as a transparent quartz or PTFE support. However, any suitable support may be used. The support is suitably flat.

In one example, the support has a thickness of up to 15 mm, suitably up to 12 mm or up to 10 mm. In one example, the thickness of the support is 10 mm. The support suitably has a thickness of up to 5 mm, such as up to 4 mm or up to 3 mm. In one example, the support has a thickness of 2 mm. The support suitably comprises a rectangular cross-section.

However, these dimensions may be modified accordingly with the size of the gliding arc discharge device.

In one example, the gliding arc discharge device comprises at least two pairs of thin diverging stainless steel electrodes. This may alternatively be referred to as a “dual”, “scale up” or “multi” GAD device. Suitably each pair will be positioned at opposite ends of a chamber.

The feed gas (which comprises methane, suitably pure methane) is introduced through a nozzle. The nozzle is suitably cylindrical with a diameter of up to 5 mm, for example up to 2 mm. In one example, the nozzle has a diameter of 1 mm. The nozzle is suitably positioned above the tip of the electrodes, such as positioned at 5 mm above the tip of the electrodes, where the narrowest gap distance is 2 mm.

In one example, the GAD device is powered by a pulsed power supply source with a voltage range of 0-20 kV, a pulse width range of 1 ns-1 ms, a rising time of 50 ns, a falling time of 50 ns, and/or a frequency range of 1 Hz-100 KHz. In one example, the GAD device is powered by an AC power supply source with a peak-to-peak voltage range of 0-10 KV, which is regulated through a transformer, and a fixed frequency of 50 Hz or optionally an adjustable frequency range from 1 Hz to 100 KHz.

The gas flow rates of the feed gas comprising methane is controlled by a mass flow controller with a gas flow of greater than 0.5 L/min. In one example, the gas flow is in a range of 0.5 to 10.0 L/min. In one example, a gas flow of greater than 10 L/min is used.

In one example, the GAD device is operated at a flow rate range of 3.5-5.5 L/min, a discharge power range of 25-65 W, and a fixed frequency of 50 Hz.

In one example, the apparatus comprises a source of external heat to provide additional heat to the reaction when in use. However, this is not preferred. In one preferred example, the apparatus does not comprise an or any external heating source(s).

The apparatus may comprise additional safety features. For example, the apparatus may comprise an additional cooling source to reduce temperature when the apparatus is in use. However, this is not preferred. In a preferred example, the apparatus does not comprise any cooling sources.

For example, conventional apparatuses often operate at high temperatures and are therefore energy-intensive. Additionally and/or alternatively, conventional apparatus typically requires cooling, since direction is exothermic, to attenuate heating. In contrast, the apparatus according to the first aspect may not require additional cooling since the reaction temperature is relatively low.

Suitably the formed carbon nanomaterials and optionally further carbon will be collected using a filter. Any suitable filter may be included in the apparatus.

Suitably, the device may also further comprise a means for separating hydrogen. Suitably any unreacted methane can be recycled. Suitable means include a pressure swing adsorption (PSA) process, a cryogenic (liquefaction) process or a membrane separation process

The GAD device may comprise a catalyst. However, this is not preferred. In one example, the GAD device does not comprise a catalyst or any precious materials, for example gold, silver, platinum, and palladium.

### Method

According to a second aspect of the present invention, there is provided a method of forming hydrogen and carbon nanomaterials from methane, the method comprising:
generating a plasma using a gliding arc discharge (GAD) device; and
reacting the methane in the generated plasma at temperatures of at most 400° C. and atmospheric pressure, thereby forming the hydrogen from at least some of the methane.

In one example, the method is carried out using an apparatus according to the first aspect.

The hydrogen, the carbon nanomaterials, the methane, the plasma and the GAD device may be as described with respect to the first aspect. The method may include any of the steps and/or features described with respect to the first aspect, mutatis mutandis.

The reaction temperature (i.e. the temperature at which the methane is exposed to the generated plasma) is at most 400° C., and more preferably at most 300° C. or at most 250° C. The reaction temperature may suitably be described as “low” temperature.

In one example, the method comprises externally heating the methane, for example using an external source of heat. However, this is not preferred. In one preferred example, the method comprises no external heating. In this way, the reaction temperature is provided, for example at least partly and/or fully, by the generated plasma.

The method according to the second aspect offers a significant advantage over conventional methods as the reaction may be performed at relatively low temperatures, without an external source of heat. This reduces the energy consumption and capital cost of the process. Additionally and/or alternatively, it is not necessary to remove heat from the process or provide processes to prevent overheating of the process.

Additionally and/or alternatively, since the reaction may be performed at relatively low temperatures, the method may be initiated (i.e. switched on) and/or paused or terminated (i.e. switched off) on demand, for example immediately or instantly, since pre-heating is not required, for example.

Since the generated plasma reaches a stable state in a relatively short time, the method may be stopped and subsequently restarted without any additional waiting time, improving an efficiency of the process. In this way, the process provides great flexibility to be integrated with renewable energy sources such as wind and solar power, especially the use of intermittent renewable energy during peak load for localised or distributed energy storage.

The reaction pressure (i.e. the pressure at which the methane is exposed to the generated plasma) is approximately ambient pressure. It should be understood that approximately ambient pressure is the substantially natural pressure of the environment, for example about 101 kPa.

In one example, the method comprises exposing the methane to the generated plasma in the presence of other gases, for example inert gases such as nitrogen, oxygen and/or impurities such as carbon dioxide and short chain hydrocarbons. However, in one preferred example only methane and unavoidable impurities are present, notwithstanding reaction products including hydrogen and carbon nanomaterials. In one particularly preferred example, the method of the second aspect does not take place in the presence of carbon dioxide and/or no carbon dioxide is formed.

The conversion of methane (χ_{CH4}) is calculated using the following equation:

$${X}_{{CH}_{4}} ( \% ) = \frac{{CH}_{4} converted ( mol / s )}{{CH}_{4} input ( mol / s )} \times 100 \qquad ( 1 )$$

The conversion of methane is suitably greater than 10%, for example greater than 20% or greater than 30%. The conversion of methane is suitably greater than 40%, for example greater than 60%, suitably greater than 80%. In one example, the conversion is suitably greater than 90%.

The selectivity of gas products can be determined as follows:

$${Y}_{{H}_{2}} ( \% ) = \frac{2 \times {H}_{2} produced ( mol / s )}{4 \times {CH}_{4} converted ( mol / s )} \times 100 \qquad ( 2 )$$

$${Y}_{{C}_{x} {H}_{y}} ( \% ) = \frac{x \times {C}_{x} {H}_{y} produced ( mol / s )}{{CH}_{4} converted ( mol / s )} \times 100 \qquad ( 3 )$$

The selectivity of hydrogen is in a range from 50 to 100%, suitably in a range from 60 to 90%, most preferably in a range from 70 to 90%. In one example, the selectivity of hydrogen is greater than 80%, for example greater than 85%, such as greater than 90%. In one example, the selectivity of hydrogen is 100%.

The discharge power of the gliding arc is determined through the integral of arc voltage multiplied by arc current:

$$P ( W ) = \frac{1}{T} {\int }_{0}^{t = T} U ( t ) \times I ( t ) dt \qquad ( 4 )$$

The specific energy input (SEI) is given by Eq. (5).

$$SEI ( kWh / {m}^{3} ) = \frac{P ( kW )}{Total flow rate ( {m}^{3} / h )} \qquad ( 5 )$$

The SEI is suitably in a range of from 200 to 1000 J/L, for example 300 to 900 J/L.

The energy efficiency of methane conversion (η_{Con}), the energy cost of hydrogen production (EC_{H2}), and the fuel production efficiency (FPE) of the plasma process are defined as:

$${η}_{C o n} ( g / kWh ) = \frac{converted {CH}_{4} ( g / {m}^{3} )}{SEI ( kWh / {m}^{3} )} \qquad ( 6 )$$

$${EC}_{{H}_{2}} ( kWh / kg {H}_{2} ) = \frac{SEI ( kWh / {m}^{3} )}{produce {H}_{2} ( kg / {m}^{3} )} \qquad ( 7 )$$

$$FPE ( \% ) = \begin{matrix}\text{} \frac{\sum fuel produced ( mol / s ) \times LHV ( kJ / mol )}{{CH}_{4} converted ( mol / s ) \times LHV of {CH}_{4} ( kJ / mol ) + Disc h a rge} ( kW ) \times 100 & ( 8 )\end{matrix}$$

where LHV is the low heating value of the fuel.

In one example, the energy efficiency of methane conversion (η_{Con}) is suitably in a range of from 100 to 400 g/kWh, such as in a range of from 125 to 350 g/kWh, suitably in a range of from 150 to 300 g/kWh.

In one example, the energy cost of hydrogen production (EC_{H2}) is suitably in a range of from 10 to 40 kWh/kg H₂, suitably in a range of from 20 to 35 kWh/kg or in a range of from 10 to 15 kWh/kg H₂. For example, the energy cost of hydrogen production may be less than 30 kWh/kg H₂, for example less than 25 kWh/kg H₂, such as less than 20 kWh/kg H₂ or less than 15 kWh/kg H₂.

In one example, the fuel production efficiency (FPE) is suitably in a range of from 60 to 95%, for example in a range of from 65 to 90%, such as 75 to 85%.

In one example, the gas flow rate of methane is suitably in a range from 3.0 to 7.0 L/min, preferably in a range from 4.0 to 6.0 L/min. The gas flow rate of methane is suitably 4.5 L/min.

However, as will be appreciated by the skilled person, the values described herein can be modified

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 shows (a) schematic diagram of the experimental setup; (b) configuration of the dual gliding arc reactor.

FIG. 2 shows the effect of total flow rate on the (a) methane conversion and energy efficiency for methane conversion; (b) H₂ selectivity, FPE, and energy cost of H₂ production (discharge power 45 W, 100% CH₄).

FIG. 3 shows the effect of discharge power on the (a) methane conversion and energy efficiency for methane conversion; (b) H₂ selectivity, FPE, and energy cost of H₂ production (total flow rate 4.5 L/min, 100% CH₄).

FIG. 4 shows the effect of additional N₂ content on the (a) methane conversion and energy efficiency for methane conversion; (b) H₂ selectivity, FPE, and energy cost of H₂ production (discharge power 45 W, total flow rate 4.5 L/min).

FIG. 5 shows representative TEM images of the carbon nanomaterials from the plasma cracking of methane, showing overall morphology of the aggregated carbons in the sample at lower magnification a (scale bar 200 nm), morphology of graphene flakes b (scale bar 100 nm), morphology of the carbon particles at medium magnification c, e (scale bar 50 nm), and the graphitic/CNT nature with higher magnification d, f (scale bar 10 nm) allowing the identification of ordered domains within the samples (discharge power 45 W, total flow rate 4.5 L/min, 100% CH₄).

FIG. 6 shows the XRD pattern of carbon generated in the plasma cracking of methane (discharge power 45 W, total flow rate 4.5 L/min, 100% CH₄).

FIG. 7 shows a Raman spectrum of carbon produced in the plasma cracking of methane (discharge power 45 W, total flow rate 4.5 L/min, 100% CH₄).

### EXAMPLES

### Reactor Set-Up

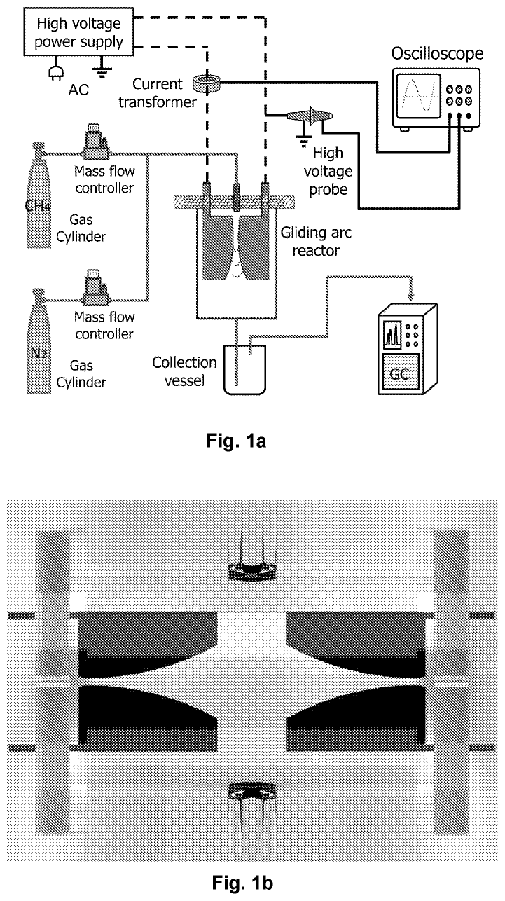

The experiment was carried out in a traditional GAD system operated at low temperature (less than 250° C.) and atmospheric pressure. Two diverging stainless-steel electrodes (60 mm in length, 18 mm in width) were installed 3 mm downstream of the nozzle exit with a minimum discharge gap of 2 mm. The plasma system was connected to an AC high voltage neon transformer with a maximum peak-to-peak voltage of 10 KV and a fixed frequency of 50 Hz. A high voltage probe (Testec, TT-HVP 15 HF) was used to measure the arc voltage, while a current monitor (Magnelab CT-E0.5) was used to record the arc current. Both electrical signals were sampled by a four-channel digital oscilloscope (Tektronix, MDO3024). FIG. 1(a) presents a schematic of the reaction system.

FIG. 1(b) demonstrates the configuration of a dual GA reactor designed to scale up the system for future applications. This reactor contained a cylindrical quartz chamber with a length of 105 mm and an outer diameter of 60 mm. Two pairs of diverging stainless-steel electrodes with 60 mm length, 18 mm width, 2 mm discharge gap (identical with the single GAD reactor) were positioned oppositely at both sides of the chamber. A distance of 20 mm was used in the centre of the chamber between the two pairs of electrodes. In both single and dual configurations, the gas temperature in the gliding arc reactor was measured by a fibre optic thermometer (Omega, FOB102) with the fibre placed 70 mm downstream of the nozzle exit.

### Product Analysis

Pure CH₄ (BOC, zero grade) or mixture of CH₄ and N₂ (BOC, zero grade) were used as the feed gases and were introduced into the GAD reactor by mass flow controllers (Omega, FMA-2404). A collection vessel was placed at the exit of the gliding arc reactor for the collection of solid carbon. The feed and product gases were analysed by a two-channel gas chromatograph (Shimadzu, GC-2014) equipped with a flame ionization detector (FID) and a thermal conductivity detector (TCD). The GC was calibrated for a wide range of concentrations for each gaseous component using standard gas mixtures (Air Liquide) and other calibrated gas mixtures. Each experiment was repeated 3 times, and the margin of error in this work was within 3%. In general, the single and dual GAD reactors showed comparable performance in the methane cracking reaction. The dual GAD reactor is a scale-up technique of the same process. The results are derived from the single GAD reactor unless further specified.

### Characterisation of Carbon Materials

In this study, images of the carbon materials were recorded using multipurpose transmission electron microscope (JEOL, JEM-2100+) with ultrahigh TEM resolution as high as 0.19 nm. X-ray diffraction (XRD) patterns of the carbon samples were obtained by an automated X-ray diffractometer (Rigaku, SmartLab) equipped with nickel-filtered Cu Kα radiation in the 2θ range of 5° to 90° with a scan rate of 4°/min. The diffraction lines were identified by matching them with reference patterns in the JCPDS database. The Raman analysis was conducted using a compact Raman spectrometer (Renshaw, RM-2000) equipped with a laser at an excitation wavelength of 514 nm.

### Results and Discussion

The LHV of various fuels is given in Table 1 below.

TABLE 1
The LHV of different fuels (kJ/mol, 25° C.)

| Fuel | CH₄ | C₂H₂ | C₂H₄ | C₂H₆ | C₃H₈ | C₄H₁₀ | H₂ |
|---|---|---|---|---|---|---|---|
| LHV | 802.8 | 1255.8 | 1322.0 | 1431.7 | 2043.2 | 2657.5 | 242.3 |

### Influence of Total Flow Rate

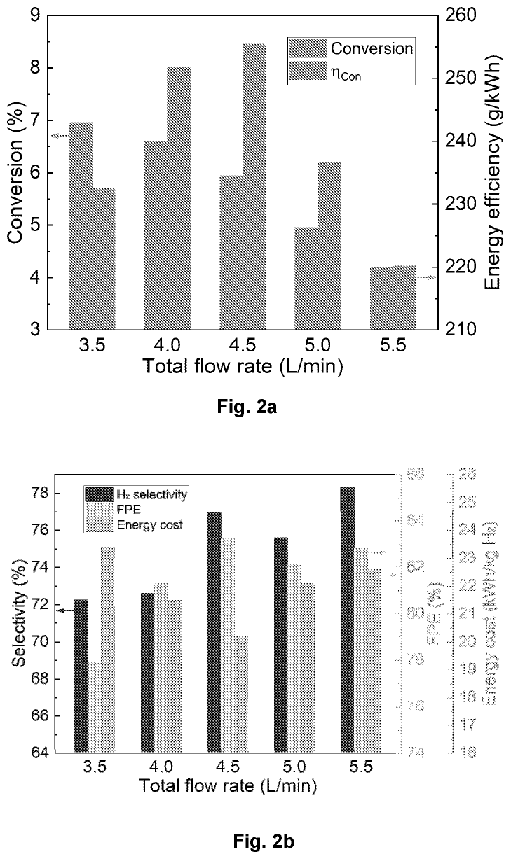

The FIG. 2(a) shows the effect of total flow rate on the methane conversion and energy efficiency for methane conversion. The conversion of methane decreased from 7.0% to 4.2% with the increase of flow rate from 3.5 to 5.5 L/min. Increasing total flow rate decreased the residence time of reactant in the discharge area thus reducing the chance of methane and its fragments reacting with the chemically reactive species such as energetic electrons and radicals in the plasma reaction. However, the low flow rate limits the total number of reactant molecules passing through the plasma zone, thus reducing the amount of converted methane. Therefore, a trade-off effect can be clearly observed in the energy efficiency for methane conversion. The energy efficiency for methane conversion increases with the elevated total flow rate and reaches a plateau at a methane flow rate of 4.5 L/min, while further increasing the flow rate to 5.5 L/min reduces the energy efficiency of methane conversion.

The gaseous products identified in this reaction included H₂ and hydrocarbons (CH₄, C₂H₂, C₂H₄, C₂H₆, C₃H₈, and C₄H₁₀) with H₂ being the most dominant products (˜80 vol. %). As seen in FIG. 2(b), increasing the gas flow rate generally enhanced the selectivity of hydrogen from 72.3% to 78.3%. A similar tendency of conversion and hydrogen selectivity has also been reported previously using needle-to-plate discharge reactor and gliding arc reactor for methane conversion. The FPE and energy cost of H₂ production showed a similar evolution as the energy efficiency for methane conversion and reached the optimal value of 83.2% and 20.2 kWh/kg H₂, respectively, at a gas flow rate of 4.5 L/min. According to the results above, the total flow rate at 4.5 L/min is favourable in terms of energy cost and FPE.

### Influence of Discharge Power

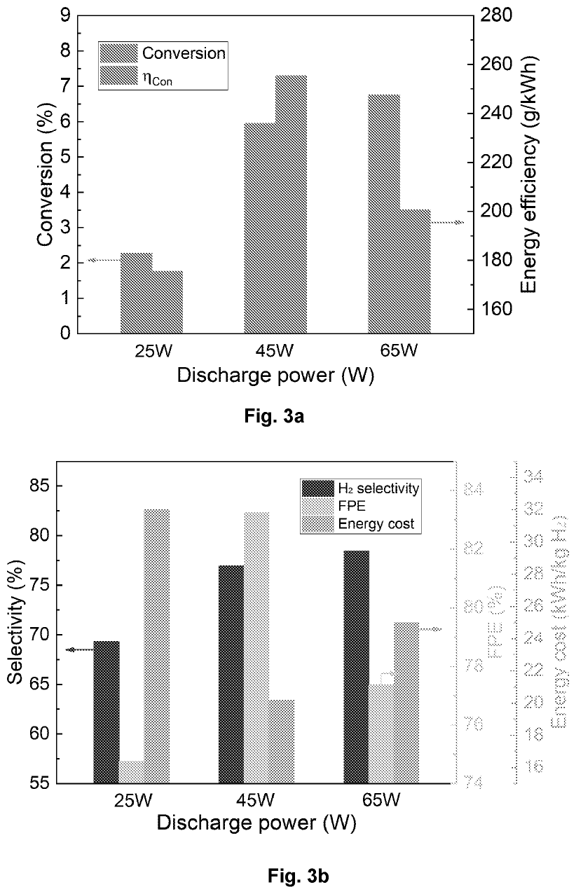

FIG. 3 shows the methane conversion and energy efficiency for methane conversion as a function of discharge power while keeping the total flow rate constant. The conversion of methane was almost tripled from 2.3% to 6.7% when varying the discharge power from 25 to 65 W, which can be attributed to the increased power input to the plasma cracking process. Note that the energy efficiency for methane conversion of this process reached the maximum value of 255.4 g/kWh at 45 W rather than declining when changing the discharge power from 25 to 65 W. This result provides valuable information that a trade-off between the efficiency and conversion was observed and a moderate discharge power is more desirable for future application.

As shown in FIG. 3(b), increasing the discharge power enhanced the selectivity of hydrogen. The H₂ selectivity was enhanced from 69.3% to 78.4% with the increase of discharge power from 25 to 65 W. The enhanced process performance, including methane conversion and gas selectivity can be attributed to the elevated power input resulting in the generation of more electrons and reactive species for the chemical reactions. Even so, similarly with the energy efficiency for methane conversion, the FPE of 83.2% and energy cost for H₂ production of 20.2 kWh/kg H₂ were achieved at a moderate discharge power of 45 W.

### Influence of N₂ Addition

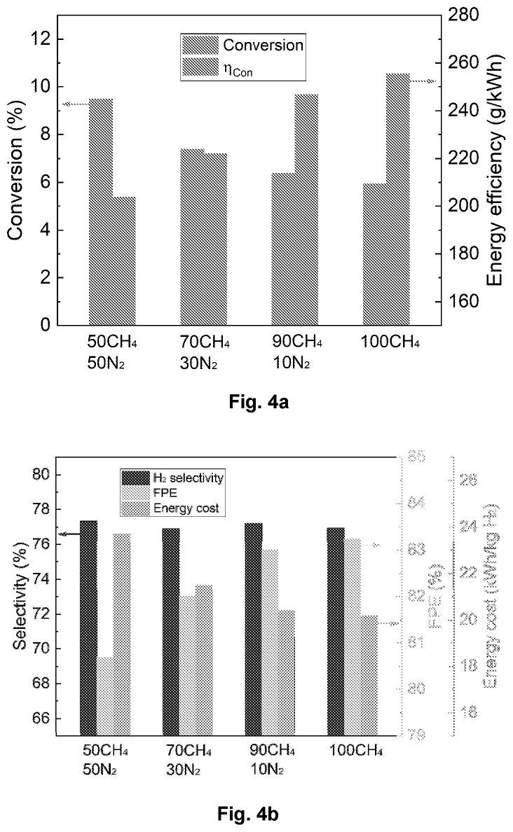

FIG. 4(a) plots the effect of N₂ addition on the methane conversion and energy efficiency for methane conversion in the plasma cracking of methane with N₂ addition. The methane conversion declined from 9.5% to 5.9% when decreasing the N₂ content at a fixed discharge power, which can be attributed to a decrease in the power density per reactant molecule. Similar trend of the methane conversion was also reported in a previous study using a rotating gliding arc reactor. The energy efficiency for methane conversion increased 203.8 to 255.4 g/kWh when increasing the CH₄ content from 50% to 100%. Clearly, a trade-off between energy efficiency for methane conversion and methane conversion was observed, as with a higher methane proportion the total amount of converted methane molecules increased despite the decreasing conversion rate, leading to a higher energy efficiency for methane conversion.

FIG. 4(b) shows that the selectivity of hydrogen remained stable at around 77.0%, with only minor fluctuations when decreasing the N₂ content. In addition, the FPE increased from 80.7% to 83.2% and the energy cost for H₂ production decreased from 23.7 to 20.2 kWh/kg H₂ with the decrease of the N₂ content. This phenomenon can be attributed to the increased amount of converted methane and enhanced hydrogen yield when increasing the proportion of methane.

### Morphology and Structure of Carbon Nanomaterials

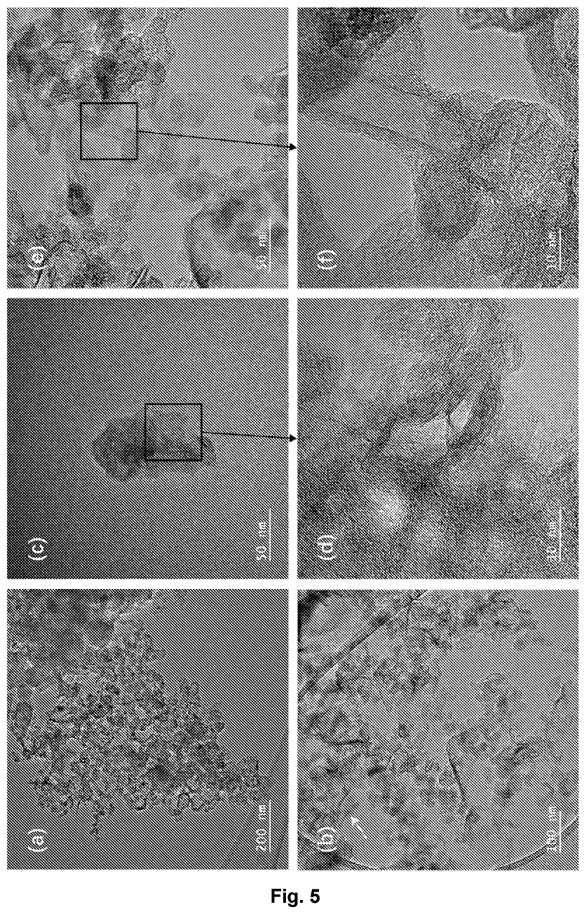

TEM measurements were performed on the obtained carbon materials. Representative TEM images of carbon nanomaterials are shown in FIG. 5. FIG. 5(a) shows the general morphology of the aggregated carbons. The presence of graphene flakes can be seen in FIG. 5(b). Graphene is one of the most promising nanomaterials and can be many sectors including energy, medicine, electronics, composites, and sensors. FIG. 5(c) & (e) demonstrate the formation of carbon nanoparticles with a diameter of 20-50 nm. In FIG. 5(d) & (f), the ordered domains within the bigger aggregates become visible and their sizes were studied. In FIG. 5(d), the graphitic layers of the carbon can be clearly observed with higher magnification, indicating the production of abundant graphite in this process. The distance between these layers was determined as around 0.3 nm. The produced graphite is in growing demand in some promising industrial applications, such as the fabrication of anode in batteries. Interestingly, the multiwall carbon nanotubes (MWCNTs) were also observed in the carbon samples with diameters ranging from 2-3 nm grow in a parallel mode and share a same wall, as seen in FIG. 5(f). The thickness of the wall for the MWCNTs is approximately 0.3 nm, while the diameter of the hollow core is about 2 nm. The MWCNTs are considered as attractive candidates in diverse nanotechnological applications, including fillers in polymer matrixes, molecular tanks, (bio) sensors due to their extraordinary mechanical properties.

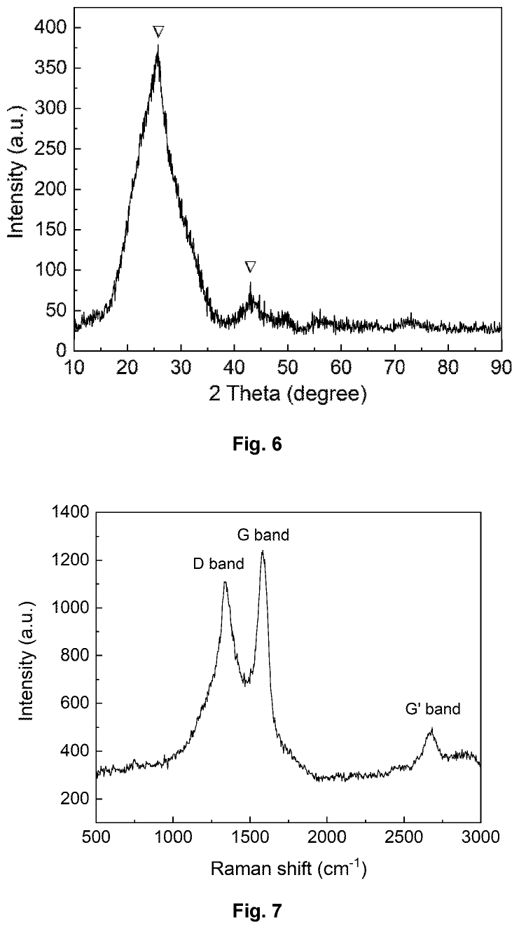

XRD analysis has been performed to examine the crystalline phase of carbon nanomaterial generated in the plasma methane cracking process. As shown in FIG. 6, the X-ray diffraction pattern of the carbon presents a broad characteristic peak at 25.9°, which can result from the overlapping of graphite and graphene peaks, suggesting the formed carbon contains a mixed graphite and graphene structure. The diffraction peak at around 43.1° can be associated with the convolution of the (101) and (100) peaks of graphitic structure.

Raman spectroscopy is one of the most powerful techniques to determine the quality of carbon nanomaterials. The Raman spectra of the carbon produced in the GAD plasma is shown in FIG. 7. The intense G-band (˜1580 cm⁻¹) emission caused by the stretching vibration mode of a sp²-like carbon is clearly observed in the measured spectra. The peak at ˜1340 cm⁻¹ (D band) is associated with the defects of the carbon. The strong D band in FIG. 7 indicates that this process produces graphene with defects. The G′ (or 2D) band at 2650 cm⁻¹ is attributed to the overtone of the D band. The shape of the G′ band and the ratio between the intensity of the G and G′ band indicate the formation of multilayer graphene.

### CONCLUSION

A gliding arc reactor has been developed herein for the co-generation of CO₂-free hydrogen and carbon nanomaterials via plasma methane cracking at low temperatures and ambient pressure. The methane conversion, hydrogen selectivity, energy efficiency for methane conversion, energy cost of H₂ production, and FPE can be tuned by controlling the process parameters including total flow rate, discharge power, and N₂ addition. The hydrogen selectivity, energy efficiency for methane conversion, energy cost of H₂ production, and fuel production efficiency reached 76.9%, 255.4 g/kWh, 20.2 kWh/kg H₂, and 83.2%, respectively, at a discharge power of 45 W and with a methane conversion of 5.9%. This disruptive technology can produce CO₂-free hydrogen and remove carbon (in the form of carbon materials) from the carbon cycle and create additional revenue streams from the sale of carbon materials (e.g., graphite, graphene, and carbon nanotubes) to further reduce the cost of hydrogen production. The morphology of produced carbon nanomaterials was analysed by TEM, XRD, and Raman spectroscopy, indicating the formation of value-added graphite, multilayer graphene, and multiwall carbon nanotubes. A novel dual gliding arc reactor was designed to scale-up the reaction system.

1. An apparatus for forming CO₂-free hydrogen and carbon nanomaterials from methane, the apparatus comprising:
a gliding arc discharge, GAD, device arranged to generate a plasma; and
a passageway including an inlet for the methane and an outlet for the hydrogen and carbon and/or carbon nanomaterials, wherein the passageway extends, at least in part, through the GAD device wherein, in use, the methane is reacted in the generated plasma at temperatures of at most 400° C. and atmospheric pressure, thereby forming the hydrogen from at least some of the methane.

2. The apparatus according to claim 1, wherein the apparatus further forms carbon.

3. The apparatus according to claim 1, wherein the carbon nanomaterials comprise at least one of graphite, graphene and carbon nanotubes.

4. The apparatus according to claim 1, wherein the methane is reacted in the generated plasma at temperatures of at most 300° C.

5. The apparatus according to claim 1, wherein the GAD device comprises at least a pair of diverging electrodes.

6. The apparatus according to claim 5, wherein the GAD device comprises two pairs of diverging steel electrodes.

7. The apparatus according to claim 1, wherein the GAD device does not comprise a catalyst or any precious materials.

8. A method of forming CO₂-free hydrogen and carbon nanomaterials from methane, the method comprising:
generating a plasma using a gliding arc discharge device; and
reacting the methane in the generated plasma at temperatures of at most 400° C. and atmospheric pressure, thereby forming the hydrogen from at least some of the methane.

9. The method according to claim 8, wherein the method further forms carbon.

10. The method according to claim 8, wherein the carbon nanomaterials comprise at least one of graphite, graphene and carbon nanotubes.

11. The method according to claim 8, wherein reacting the methane in the generated plasma at temperatures less than 300° C.

12. The method according to claim 8, wherein the conversion of methane is in a range from 2 to 20%.

13. The method according to claim 8, wherein the selectivity of hydrogen is in a range from 50 to 90%.

14. The method according to claim 8, wherein the gas flow rate of methane is in a range from 3.0 to 7.0 L/min.

15. The apparatus according to claim 2, wherein the carbon comprises carbon black.

16. The apparatus according to claim 1, wherein the methane is reacted in the generated plasma at temperatures of at most 250° C.

17. The apparatus according to claim 6, wherein each pair of electrodes is positioned opposite to one another.

18. The method according to claim 8, wherein the conversion of methane is in the range of 4 to 10%.

19. The method according to claim 8, wherein the selectivity of hydrogen is in a range from 70 to 90%.

20. The method according to claim 8, wherein the gas flow rate of methane is in a range from 4.0 to 6.0 L/min.
